(19) United States
(12) Patent Application Publication
(10) Pub. No.: US 2017/0072420 A1
(43) Pub. Date: Mar. 16, 2017

(54) Spray boom cleanout assembly

(71) Applicant: Michael S. Meyer, Clear Lake, IA (US)

(72) Inventor: Michael S. Meyer, Clear Lake, IA (US)

(73) Assignee: Hagie Manufacturing Company, Clarion, IA (US)

(21) Appl. No.: 14/856,008

(22) Filed: Sep. 16, 2015

(51) Int. Cl. B05B 15/02; A01C 23/04; A01M 7/00

(52) U.S. Cl. CPC B05B 15/0258; A01M 7/0071; A01C 23/047

(57) ABSTRACT

A system and method for spray boom cleanout. A spray boom cleanout assembly is provided over a fluid pipe of an agricultural sprayer. The spray boom cleanout assembly includes an end cap body having a vent configured to release trapped air from the fluid pipe through a spray nozzle as the fluid pipe is filled with a fluid. The end cap body is coupled by an adapter to a fluid flush valve allowing for improved cleanout of fluid from the end of the fluid pipe after a spraying operation.

### TECHNICAL FIELD

The disclosed embodiments relate in general to an agricultural spray boom cleanout assembly, and more specifically, to an agricultural spray boom pipe end cap assembly with a cleanout valve.

### BACKGROUND OF THE INVENTION

Agricultural spray booms are known in the art. Such vehicles include a tank with material to be applied to an agricultural field and a spray boom to apply the material to the field. Agricultural spray booms supply fluid material to nozzles provided on the booms through a fluid pipe. The spraying functions associated with the nozzles are controlled by a diaphragm that turns the nozzles on and off. If air becomes trapped in the fluid pipe supplying fluid to the nozzles, the compressive nature of air trapped within the fluid pipes can cause a delay in actuation of the diaphragm turning the nozzles on and off. It would therefore be desirable to reduce the amount of air in the fluid pipe to increase the responsiveness of the diaphragm in turning on and off the nozzles.

It is known in the art to provide an end cap over the end of a spray boom fluid pipe to allow the venting of air out of the fluid pipe to increase the responsiveness of the diaphragm controlling the nozzles. One such device known in the art is a Hypro® model 7433 Express Nozzle Body End Cap, manufactured by Pentair Ltd., of Minneapolis Minn. Such prior art end caps eliminate trapped air from the fluid pipe of the boom by allowing air to escape through a vent, while maintaining liquid within the fluid pipe. One drawback associated with such prior art end caps is the difficulty in flushing the fluid pipe. Such prior art devices have a cover that can be removed for cleanout. Removal of the cover, however, requires manual manipulation. One drawback associated with such systems is that while manipulating the cover the user may come into contact with potentially hazardous fluid contained within the fluid pipe. It would therefore be desirable to provide a system for removing trapped air from the fluid pipe, while reducing user contact with fluid contained within the pipe during cleanout.

Another drawback associated with such prior art systems is the difficulty and time consuming nature associated with removing and replacing the cover for cleanout of the spray boom fluid pipe. Cleanout using such systems involves multiple steps including releasing a locking pin, maintaining the cover in place, and thereafter removing the cover. Additionally, since the pin and cover are no longer connected to the assembly after removal, these small pieces can become lost during the cleanout phase, which can lead to significant down time of the sprayer while replacements are located and installed.

It is also known in the art to provide boom end flush out valves to reduce user contact with fluid in the boom pipe during flushing and cleanout of the pipe. One such prior art system is the Wilger End Flush Valve Model #WL25176, manufactured by Wilger Industries Ltd. of Saskatoon, Saskatchewan, Canada. One drawback associated with such prior art systems is the inability of such systems to remove trapped air from the fluid pipe. It would therefore be desirable to provide a boom end flush valve that allowed for removal of trapped air within the fluid pipe of a spray boom.

In light of the foregoing, it would be desirable to provide an end cap spray boom fluid pipe cleanout assembly that allows for the removal of trapped air and easy rapid cleanout of the fluid pipe, while reducing user contact with fluid contained within the fluid pipe. The difficulties discussed herein above are sought to be eliminated by the present invention.

### SUMMARY OF THE DISCLOSED SUBJECT MATTER

The present invention includes systems and methods for purging and cleaning the fluid pipe of a spray boom. A spray boom cleanout assembly is provided and secured over the end of a fluid pipe of a spray boom. The end cap is provided with a vent configured to release trapped air from the fluid pipe, while maintaining the liquid therein. The assembly is also provided with a fluid flush valve for cleanout of the fluid pipe.

The features and advantages described in this summary and in the following detailed description are not all inclusive. Many additional features and advantages may be apparent to one of ordinary skill in the art in view of the drawings, specification and claims presented herein.

### BRIEF DESCRIPTION OF THE DRAWINGS

FIG. 1 illustrates a front elevation of an agricultural sprayer having the spray boom cleanout assembly of the present invention;

FIG. 2 illustrates an exploded view of the spray boom cleanout assembly of FIG. 1;

FIG. 3 illustrates a side perspective view of the spray boom cleanout assembly of FIG. 1;

FIG. 4 illustrates a bottom elevation of the adapter of the spray boom cleanout assembly of FIG. 1;

FIG. 5 illustrates a top elevation of the adapter of the spray boom cleanout assembly of FIG. 1;

FIG. 6 illustrates a side elevation and cut-away of the adapter of the spray boom cleanout assembly of FIG. 1;

FIG. 7 illustrates a top perspective view of the boom and flush valve of the spray boom cleanout assembly of FIG. 1; and,

FIG. 8 illustrates a side elevation in cut-away of the spray boom cleanout assembly of FIG. 1.

### DETAILED DESCRIPTION OF THE DRAWINGS

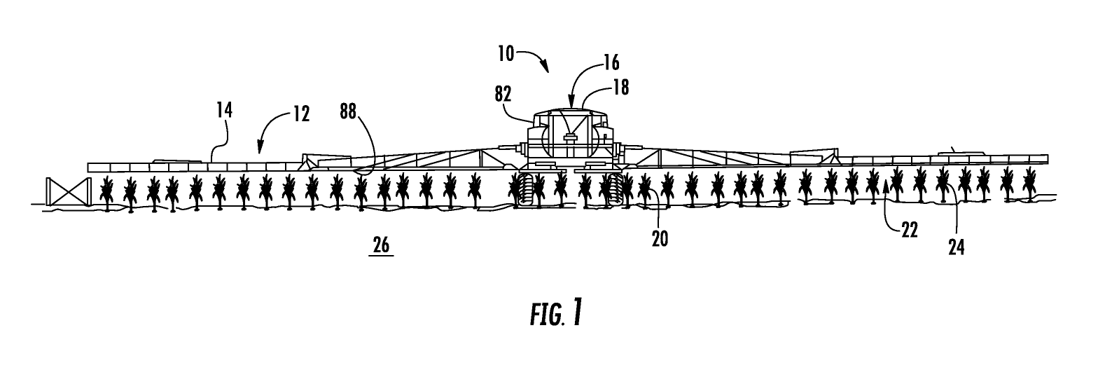

As shown in FIG. 1, a high clearance agricultural sprayer (10) is provided with a spray boom (12) coupled to the spray boom (12) is a fluid pipe (14) in fluid communication with a material tank (16) provided on the sprayer (10). While the sprayer (10) may be of any type known in the art, in the preferred embodiment, the sprayer (10) is a Hagie STS 12 Sprayer provided with a 1200 gallon material tank (16) for storing fluid (18) to be applied to crops (20), weeds (22), pests (24) and/or the soil (26).

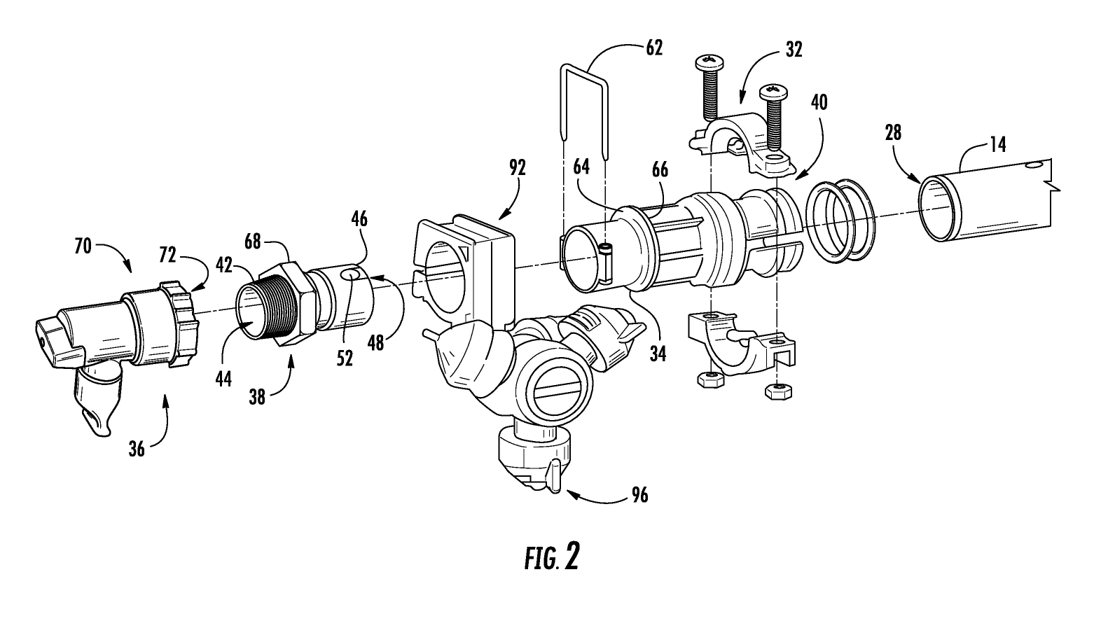

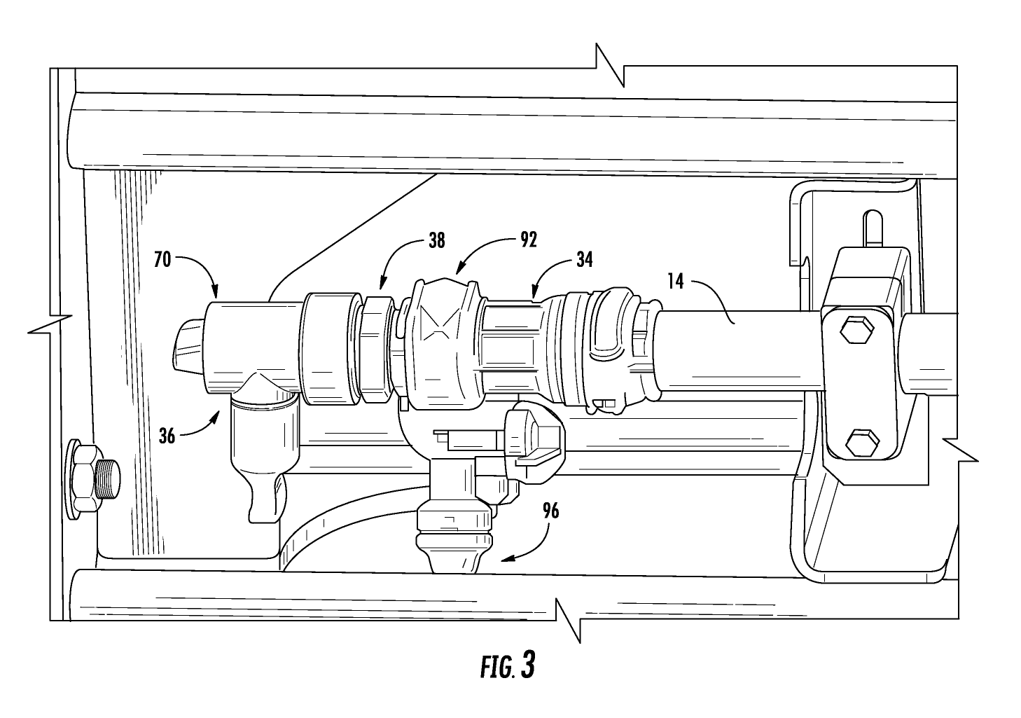

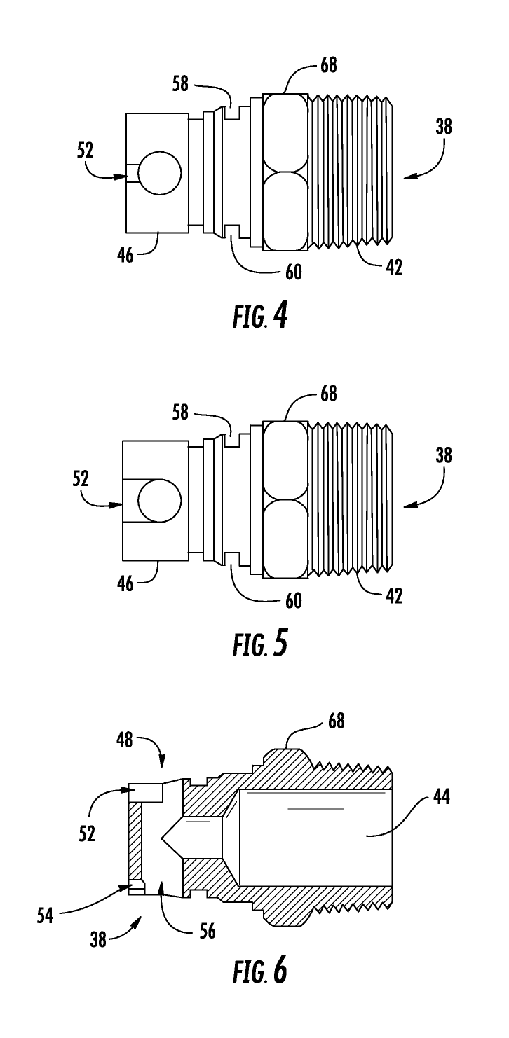

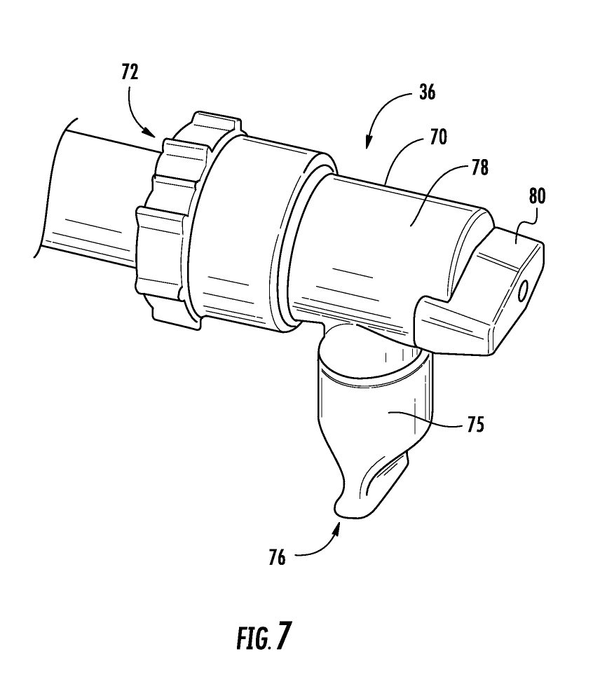

As shown in FIG. 2, secured over the end (28) of the fluid pipe (14) is a spray boom cleanout assembly (30). The spray boom cleanout assembly (30) has an end cap body (34), a nozzle assembly (92), a fluid flush valve (36) and an adapter (38) coupling the end cap body (34) to the fluid flush valve (36). One end of the spray boom cleanout assembly (30) defines a hollow receiver (40), which receives the end (28) of the fluid pipe (14). Once the end (28) of the fluid pipe (14) is received within the receiver (40), the end cap body (34) is secured to the fluid pipe (14) by a collar clamp (32), or similar means known in the art. The nozzle assembly (92) is provided over the end cap body (34), the adapter (38) is pinned into engagement with the end cap body (34) and the fluid flush valve (36) is screwed into the adapter (38). While the end cap body (34) may be of any design known in the art, in the preferred embodiment, the end cap body (34) is a Hypro® Express Nozzle Body End Cap Model 7433, manufactured by Pentair Ltd. of Minneapolis, Minn. Similarly, the fluid flush valve (36) may be of any type known in the art, but in the preferred embodiment is a Wilger boom and flush valve model number 25176-VO manufactured by Wilger Industries Ltd., of Saskatoon, Saskatchewan, Canada.

Whereas the end cap body (34) is typically provided with a removable cover (not shown), in the present invention, the cover is replaced by the adapter (34), shown in more detail in FIGS. 4-6. As shown in FIG. 4, the adapter (38) is provided with a first threaded end (42) defining a tapered cavity (44). As shown in FIG. 6, the adapter (38) is also provided with a second end (46) integrally coupled to the first threaded end (42). The second end (46) defines a fluid vent (48), having a first large port (52) and a second smaller port (54), both of which are in fluid communication with a vent channel (56). The vent channel (56) is in fluid communication with the cavity (44) of the first threaded end (42). As shown in FIG. 5, the large port (52) is approximately the same width as the diameter of the vent channel (56). As shown in FIG. 4, the small port (54) is substantially smaller width than the diameter of the vent channel (56).

As shown in FIGS. 4 and 5, the adapter (38) is also provided with a pin retainer, which in the preferred embodiment is a pair of keyways (58 & 60). As shown in FIG. 2, when the adapter (38) is positioned within the end cap body (34) a metal clip (62) is provided through two slots (64 & 66) integrally molded into the sides of the end cap body (34). As the clip (62) is positioned within the slots (64 & 66), the clip (62) passes through the keyways (58 & 60) of the adapter (38), thereby retaining the adapter (38) in engagement with the end cap body (34), against inadvertent removal. When it is desired to remove the adapter (38) from the end cap body (34), the clip (62) is removed and the adapter (38) is slid from the end cap body (34).

While the adapter (38) may be constructed of any type of material known in the art, in the preferred embodiment, the adapter (38) is integrally molded into a single piece of polypropylene. As shown in FIG. 2, the second end (46) of the adapter (38) is threaded for engagement with the fluid flush valve (36). The adapter (38) is integrally molded with a nut (68), located between the first threaded end (42) and the second end (46) of the adapter (38), to facilitate securement of the adapter (38) to the fluid flush valve (36). The fluid flush valve (36) is provided with a valve body (70) defining a threaded cavity (72). The first threaded end (42) of the adapter (38) is preferably threaded with dimensions to fit into mating engagement with the threaded cavity (72) of the fluid flush valve (36). For ease of assembly, the first threaded end (42) of the adapter (38) is preferably threaded into the threaded cavity (72) of the fluid flush valve (36) prior to inserting the second end (46) of the adapter (38) into the end cap body (34) for retainment therein by the clip (62). A wrench (not shown) may be used on the nut (68) to tighten the securement of the adapter (38) to the fluid flush valve (36) if manual tightening is insufficient for this purpose.

As shown in FIG. 7, the fluid flush valve (36) is also integrally molded with an outlet (74) defining an exhaust port (76) in fluid communication with the threaded cavity (72). Located between the threaded cavity (72) and the exhaust port (76) is a valve (78), such as those known in the art, to open and close fluid communication between the threaded cavity (72) and exhaust port (76). The valve (78) is provided with an exterior knob (80) to allow for manually opening and closing the valve (78).

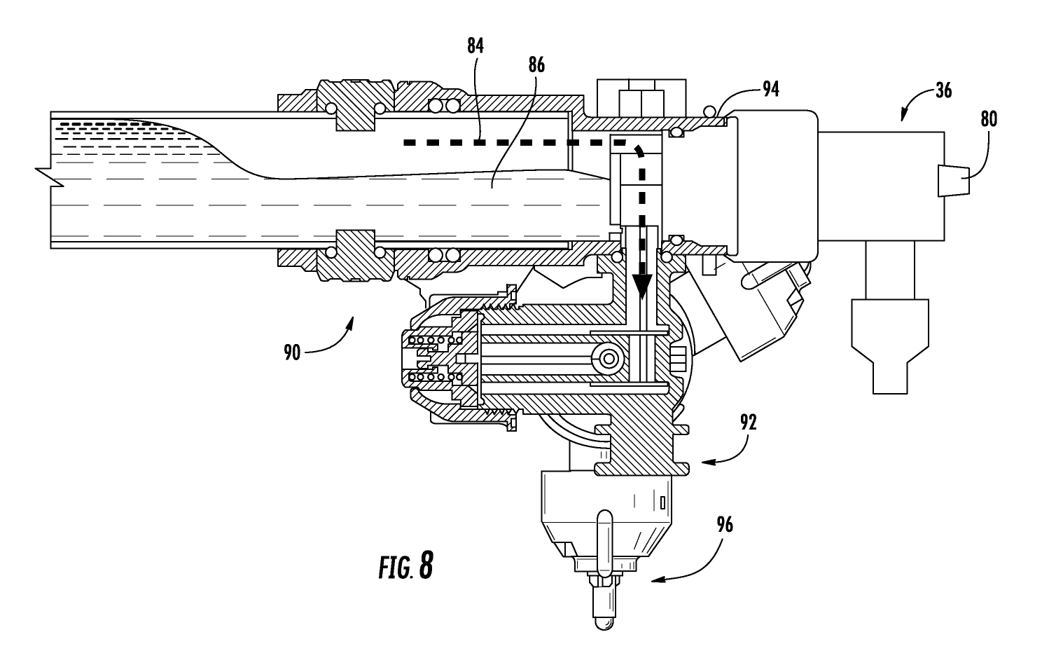

The first threaded end (42) of the adapter (38) is screwed into the threaded cavity (72) of the fluid flush valve (36) to a desired tightness. The second end (46) of the adapter (38) is then inserted into the end cap body (34) and retained therein by the clip (62). The adapter (38) is secured within the end cap body (34) in an orientation having the large port (52) on the top and the small port (52) at the bottom, to facilitate purging air (84) from the fluid pipe (14). As shown in FIG. 8, the nozzle assembly (92) is in fluid communication with the vent channel (56).

When it is desired to use the spray boom cleanout assembly (30) of the present invention, a user manipulates a control panel (82) provided on the sprayer (10) to remotely open one of the nozzles (96) on the nozzle assembly (92). Thereafter the user manipulates the control panel (82) to direct fluid (18) into the fluid pipe (14). As the fluid (18) begins to fill the fluid pipe (14), the fluid (18) remains at near the bottom of the fluid pipe (14) while air (84) within the fluid pipe (14) moves to the top of the fluid pipe (14). Given the relative sizes of the ports (52 & 54) and the relatively lower viscosity of the air (84) compared to the fluid (18), pressure caused by the fluid (18) entering the fluid pipe (14) forces more air (84) through the upper large port (52) than fluid (18) through the small port (54). This causes the air (84) to move through the large port (52), vent channel (56), through the nozzle assembly (92) and out of the nozzle (96). Air (84) continues to vent from the fluid pipe (14) through the nozzle (96) until the fluid (18) fills the fluid pipe (14), at which point fluid (18) begins to move through the large port (52) to be exhausted through the nozzle (96). Once the user sees fluid (18) exiting through the nozzle (96), the user manipulates the control panel (82) to remotely close the nozzle (96), completing the purging of air (84) from the fluid pipe (14). Allowing the use of the nozzle (96) to purge the fluid pipe (14) allows the entire purging operation to be conducted from the control panel (82) as the nozzle (96) can be remotely operated therefrom.

When it is desired to clean out the fluid pipe (14) after application of the fluid (18), the user manually turns the knob (80) on the fluid flush valve (36) to open the valve (78). The user then uses the control panel (82) to direct water or other cleaning liquid through the fluid pipe (14). Once the fluid pipe (14) has been sufficiently flushed with water (86) the user uses the control panel (82) to stop providing water (86) to the fluid pipe (14), allowing the remainder to drain from the outlet (74). Once the fluid pipe (14) is empty, the user turns the knob (80) to close the valve (78) and the sprayer (10) is again ready for use. Providing the spray boom cleanout assembly at the end (28) of the fluid pipe (14), prevents fluid (18) from remaining trapped in the fluid pipe (14) and not exiting the fluid pipe (14) during cleanout. By positioning the spray boom cleanout assembly at the end (28) of the fluid pipe (14), the fluid pipe (14) may be completely flushed of remaining fluid (18), thereby reducing the mixing of fluid (18) remaining in the fluid pipe (14) with a new fluid (18) subsequently introduced into the fluid pipe (14).

Although the invention has been described with respect to a preferred embodiment thereof, it is to be understood that it is not to be so limited, since changes and modifications can be made therein which are within the full, intended scope of this invention as defined by the appended claims. What is claimed is:

1. A spray boom cleanout assembly, comprising:
(a) an endcap body configured for securement over the end of a fluid pipe of a spray boom;
(b) wherein the endcap body is provided with a vent configured to release trapped air from the fluid pipe of the spray boom;
(c) wherein the vent is configured to impede the release of fluid from the fluid pipe of the spray boom; and
(d) a fluid flush valve coupled to the endcap body, wherein in the fluid flush valve is configured for securement in fluid communication with the fluid pipe of the spray boom.

2. The spray boom cleanout assembly of claim 1, further comprising a sprayer nozzle coupled to the endcap body, wherein in the sprayer nozzle is configured for securement in fluid communication with the fluid pipe of the spray boom.

3. The spray boom cleanout assembly of claim 2, wherein the sprayer nozzle is constructed for remote actuation.

4. The spray boom cleanout assembly of claim 2, wherein the sprayer nozzle is directed downward.

5. The spray boom cleanout assembly of claim 1, wherein the fluid flush valve is provided with a manually operable knob.

6. The spray boom cleanout assembly of claim 1, wherein the fluid flush valve is directed downward.

7. The spray boom cleanout assembly of claim 1, wherein the endcap body is provided with a receiver of a size sufficient to receive an end of the fluid pipe of the spray boom.

8. The spray boom cleanout assembly of claim 7, further comprising a clamp securing the endcap body to the fluid pipe of the spray boom.

9. The spray boom cleanout assembly of claim 1, further comprising an adapter, the adapter comprising:
(a) a first threaded end defining a cavity;
(b) a second end coupled to the first threaded end; and
(c) wherein the vent comprises a first port in fluid communication with the cavity, and a second port in fluid communication with the cavity.

10. The spray boom cleanout assembly of claim 9, wherein the first port is larger than the second port.

11. The spray boom cleanout assembly of claim 9, further comprising a nut positioned between the first end and the second end.

12. The spray boom cleanout assembly of claim 9, wherein the adapter defines a pin retainer between the first end and the second end.

13. The spray boom cleanout assembly of claim 9, wherein the vent comprises a vent channel in fluid communication between the first port and the cavity.

14. The spray boom cleanout assembly of claim 13, wherein the vent channel is in fluid communication with the second port.

15. The spray boom cleanout assembly of claim 13, wherein an axis of the vent channel is oriented generally perpendicular to an axis of the cavity.

16. A spray boom cleanout assembly comprising;
(a) an endcap body configured for securement over the end of a fluid pipe of a spray boom;
(b) wherein the endcap body is provided with a vent configured to release trapped air from the fluid pipe of the spray boom;
(c) wherein the vent is configured to impede the release of fluid from the fluid pipe of the spray boom;
(d) a fluid flush valve coupled to the endcap body, wherein in the fluid flush valve is configured for securement in fluid communication with the fluid pipe of the spray boom; and
(e) an adapter coupled to, and in fluid communication with, both the endcap body and the fluid flush valve.

17. The spray boom cleanout assembly of claim 16, wherein the adapter comprises:
(a) a first threaded end defining a cavity;
(b) a second end coupled to the first threaded end; and
(c) wherein the vent comprises a first port in fluid communication with the cavity, and a second port in fluid communication with the cavity.

18. The spray boom cleanout assembly of claim 17, wherein the cavity is in fluid communication with the endcap body and wherein the first port and the second port are in fluid communication with the fluid flush valve.

19. A spray boom cleanout assembly comprising;
(a) an endcap body configured for securement over the end of a fluid pipe of a spray boom;
(b) wherein the endcap body is provided with a vent configured to release trapped air from the fluid pipe of the spray boom;
(c) wherein the vent is configured to impede the release of fluid from the fluid pipe of the spray boom;
(d) an adapter threadably coupled to the endcap body;
(e) a fluid flush valve releasably coupled to the fluid flush valve; and
(f) wherein the vent comprises a first port and a second port both in fluid communication with the cavity and the fluid flush valve.

20. The spray boom cleanout assembly of claim 19, further comprising a pin securing the endcap body to the adapter.
